(19) United States
(12) Patent Application Publication
(10) Pub. No.: US 2026/0223831 A1
(43) Pub. Date: Aug. 6, 2026

(54) A FLYING INSECT TRAP

(71) Applicant: RENTOKIL INITIAL 1927 PLC, Crawley West Sussex (GB)

(72) Inventors: Matthew Green, Crawley West Sussex (GB); Gregory Peter Dobie Murray, London (GB); John McCaig, West Sussex (GB); Samuel Mark Plowman, East Sussex (GB)

(73) Assignee: RENTOKIL INITIAL 1927 PLC, Crawley West Sussex (GB)

(21) Appl. No.: 19/149,732

(22) PCT Filed: Jan. 22, 2024
(86) PCT No.: PCT/GB2024/050168

§ 371 Date: Jul. 21, 2025

(30) Foreign Application Priority Data
Jan. 24, 2023 (GB) 2301014.3

(51) Int. Cl. A01M 1/10; A01M 1/04

(52) U.S. Cl. CPC A01M 1/106

(57) ABSTRACT

A flying insect trap, including a housing for holding insect-killing liquid and a basket removably mounted within the housing. The basket comprises a plurality of holes, and the housing and basket are arranged so that a portion of the insect-killing liquid within the housing can pass through the holes into the interior of the basket. Each of the housing and the basket comprises at least one opening, such that a flying insect can travel from outside the housing through the at least one openings of the housing and the basket to the interior of the basket. The basket is arranged so that when the housing is holding insect-killing liquid and there are one or more insect corpses in the insect-killing liquid within the basket, when the basket is removed from the housing, the one or more insect corpses remain within the basket and are removed from the housing.

### FIELD OF THE INVENTION

The present invention concerns a flying insect trap. More particularly, but not exclusively, the invention concerns a flying insect trap with a housing for holding insect-killing liquid, in which insects are killed.

### BACKGROUND OF THE INVENTION

A known type of trap for catching flying insects, for example flies, is known as a “redtop” fly catcher. Such a trap consists of a clear plastic bag which is suspended from a rigid ring around the top of the bag, from which the trap is hung for example on a wall or the like. The bag is filled with an insect-killing liquid that attracts and kills insects, such as flies (Diptera) and social wasps (Hymenoptera). The lid has an opening through which insects can enter, leading them to be killed by the liquid. Such traps are especially used to catch large numbers of nuisance flying insects. The insect-killing liquid can for example be a sweet-or meat-smelling liquid, which attracts insects by releasing volatile chemicals to which they are attracted. While the insect-killing liquid may “actively” kill the insects by having a chemical effect on them, e.g. by poisoning them, it is usually the case that the insect-killing liquid only attracts the insects into the trap, in which they cannot escape and eventually drown.

It is a disadvantage of such traps that the corpses of the insects that have been killed by the liquid are visible through the clear plastic bag, so that the trap can become unsightly. In addition, in order to clear the trap the liquid and fly corpses are disposed of together, leading to insect-killing liquid being wasted. Due to the flexible nature of the clear plastic bag, it can also be difficult to dispose of it tidily.

The present invention seeks to solve or mitigate some or all of the above-mentioned problems. Alternatively or additionally, the present invention seeks to provide improved flying insect traps.

### SUMMARY OF THE INVENTION

In accordance with a first aspect of the invention there is provided a flying insect trap, comprising:
a housing for holding insect-killing liquid;
a basket removably mounted within the housing, wherein the basket comprises a plurality of holes, and wherein the housing and basket are arranged so that a portion of the insect-killing liquid within the housing can pass through the holes into the interior of the basket;
wherein each of the housing and the basket comprises at least one opening, such that a flying insect can travel from outside the housing through the at least one openings of the housing and the basket to the interior of the basket;
and wherein the basket is arranged so that when the housing is holding insect-killing liquid and there are one or more insect corpses in the insect-killing liquid within the basket, when the basket is removed from the housing, the one or more insect corpses remain within the basket and are removed from the housing.

As the basket comprises a plurality of holes it is permeable to liquid, meaning that when the housing (which is not permeable to the liquid) is holding a sufficient volume of insect-killing liquid, a part of the volume of insect-killing liquid will be in the interior of the basket, with the remainder outside the basket. Flying insects can then fly, via the at least one openings of the housing and the basket, to the insect-killing liquid within the basket, in which they die. Subsequently, particularly when a large number of insects have died in the insect-killing liquid, the basket can be removed from the housing in order to empty the trap. When this is done, the insect corpses will remain within the basket, so can easily be disposed of and the now-empty basket returned to the housing. However, when the basket is removed from the housing the insect-killing liquid will flow through the plurality of holes so that it remains within the housing when the basket is removed. In addition to making the emptying of the trap easy to achieve, this allows the insect-killing liquid to be reused, rather than being disposed of at the same time as the trap is emptied.

The housing may be formed of transparent material, or semi-transparent material. This allows it to be easily seen how many flying insects have been caught in the trap, and whether the insect-killing liquid required replenishment for example due to it having evaporated over time. The housing may be made of a clear plastics material, for example.

The housing may be formed of a rigid material. Alternatively, the housing may be flexible, for example a flexible plastic bag.

The basket may be formed of opaque material. Particularly when the housing is formed of transparent material, this prevents insect corpses in the insect-killing liquid in the basket being easily visible, so makes the trap less unsightly. The basket may be formed of a rigid material. The basket may comprise a mesh, for example a wire mesh. The basket may be formed entirely or substantially of mesh, or may have panels of mesh. The basket may be formed of a plastics material. The plurality of holes may be voids formed in the material of the basket. The voids may be 3-4 mm in diameter. The holes may be sized to be smaller than an adult fly, or an adult wasp, or an adult mosquito.

Any opening in the housing may allow an insect to travel only from the outside of the housing to the interior of the basket. In other words, there may be no route by which an insect could travel from outside the housing to inside the housing but outside the basket, and in particular to any liquid in the housing but outside the basket. This means all insects die in the insect-killing liquid within the basket.

The at least one openings of the housing and the basket may be at least partially aligned. This provides a route for an insect directly from the outside of the housing to the interior of the basket. The at least one openings may be completely aligned.

One or more of the at least one openings of the housing and the basket may comprise a funnel, with the smaller end of the funnel being towards the interior of the basket. This allows insects to easily enter the trap, but not easily escape. The opening of the housing, or of the basket, or both, may be funnel shaped.

The basket may be removable from the housing through an opening in the housing, and the flying insect trap may further comprise a lid that covers the opening. The lid may, for example, be hinged on the housing, or may be entirely removable from the housing, to allow the basket to be removed from the housing.

The lid may comprise at least one opening, such that a flying insect can travel from outside the housing through the at least one openings of the lid, the housing and the basket to the interior of the basket. The opening of the lid may be partially or completely aligned with the opening of the housing and/or of the basket. The at least one opening of the lid may comprise a funnel, with the smaller end of the funnel being towards the interior of the basket. This allows insects to easily enter the trap, but not easily escape. The opening of the housing and/or of the basket may also be funnel shaped.

The housing may comprise at least one further opening on a side of the housing, such that a flying insect can travel from outside the housing through the at least one further opening to the interior of the basket. The basket may comprise at least one further opening on a side of the basket, which may be partially or completely aligned with the at least one further opening on the side of the housing. At least one further opening of the housing and/or the basket may comprise a funnel. By “side” of the housing and basket is meant a horizontal side of the housing or basket when the trap is hung on a wall, as opposed to the top or bottom of the housing or basket. It has been found that wasps prefer to enter holes on the side rather than top of a trap.

The basket may be pink in colour. It has been found that the colour pink is particularly attractive to wasps. The housing may alternatively or additionally be pink in colour.

The flying insect trap may contain insect-killing liquid within the housing. The insect-killing liquid may be an insect attractant. The insect-killing liquid may be a sugar solution, a protein-based solution, or a liquid baits formulated for the attraction of specific flying insects, for example. As with the known redtop fly catcher, the insect-killing liquid may be a sweet-or meat-smelling liquid, which attracts insects by releasing volatile chemicals to which they are attracted. The insect-killing liquid may actively kill the insects by having a chemical effect on them, e.g. by poisoning them, or may only attract the insects into the trap, in which they cannot escape and eventually drown.

In accordance with a second aspect of the invention there is provided a kit of parts for a flying insect trap as described above, comprising:
a housing for holding insect-killing liquid;
a basket arranged to be removably mounted within the housing, the basket comprising a plurality of holes.

The kit of parts may further comprise a lid for covering an opening in the housing.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1a shows a flying insect trap in accordance with a first embodiment of the invention;

FIG. 1b shows the flying insect trap of FIG. 1 with its lid opened;

FIG. 2 shows the housing of the flying insect trap of FIG. 1;

FIG. 3 shows the basket of the flying insect trap of FIG. 1;

FIG. 4a shows the top of the lid of the flying insect trap of FIG. 1;

FIG. 4b shows the bottom of the lid of the flying insect trap of FIG. 1;

FIG. 5a shows the bottom of the funnel of the lid of the flying insect trap of FIG. 1;

FIG. 5b shows the top of the funnel of the flying insect trap of FIG. 1;

FIG. 6a shows the top of the cover of the lid of the flying insect trap of FIG. 1; FIG. 6b shows the bottom of the cover of the lid of the flying insect trap of FIG. 1;

FIG. 7 shoes a flying insect trap in accordance with a second embodiment of the invention;

FIG. 8 shows the housing of the flying insect trap of FIG. 7;

FIG. 9 shows the basket of the flying insect trap of FIG. 7; and

FIG. 10 shows a side funnel of the flying insect trap of FIG. 7.

### DETAILED DESCRIPTION

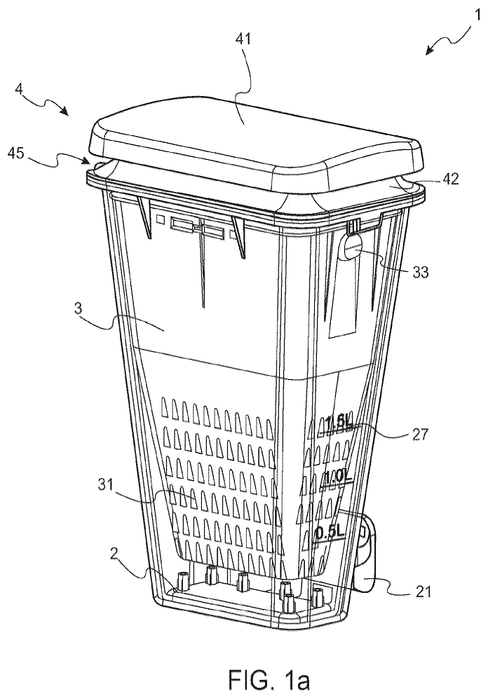

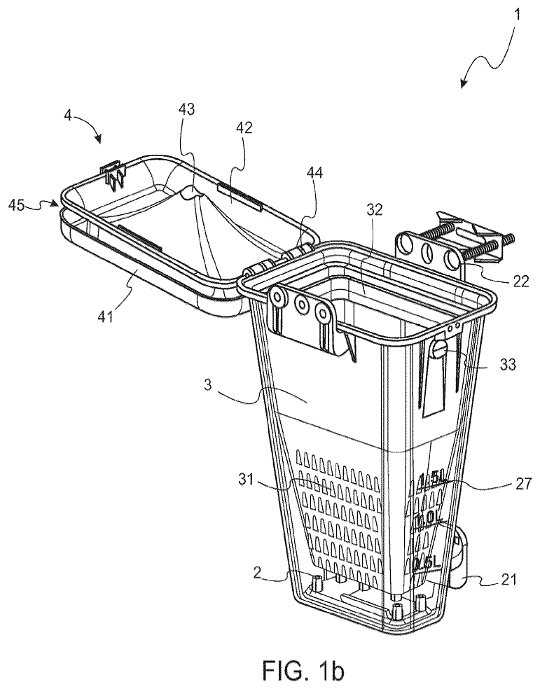

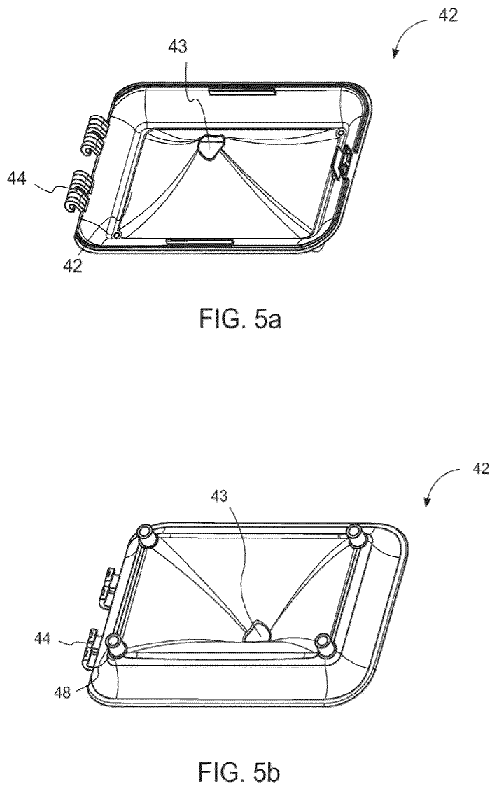

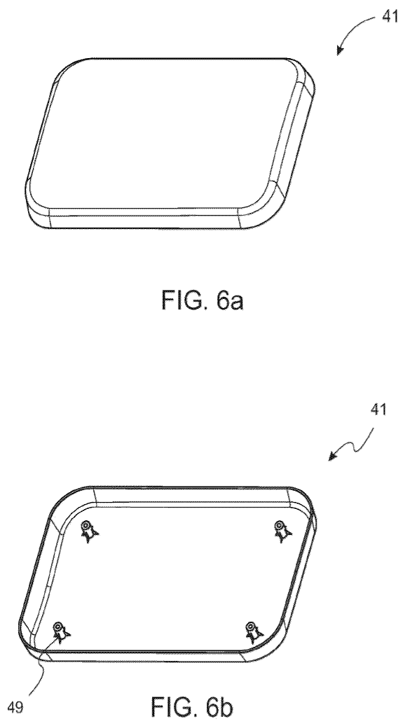

A flying insect trap in accordance with a first embodiment of the invention is now described with reference to FIGS. 1a to 6b. FIGS. 1a and 1b show the flying insect trap 1 when assembled, in a configuration with a lid 4 closed in FIG. 1a, and with it open in FIG. 1b.

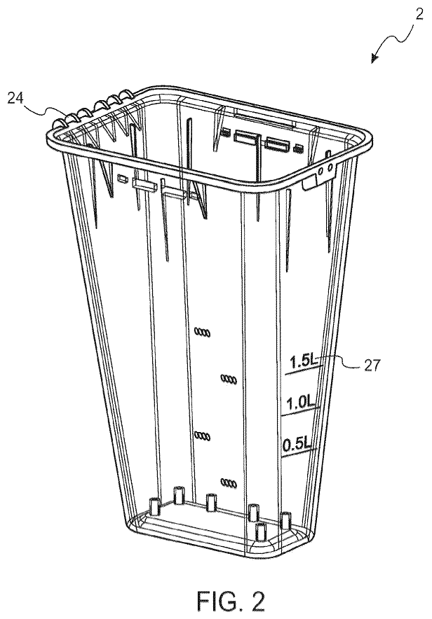

The flying insect trap 1 comprises a housing 2. The housing 2 is shown in more detail in FIG. 2. The housing 2 is rectangular in cross section, tapering at a constant rate from an open top to a closed bottom. The housing 2 is formed of a transparent plastics material. The housing 2 has on its side markings indicating the volume of liquid contained within the housing 2, for example a 1.5 L marking 27. On one edge of the top of the housing 2 are hinge fittings 24, on which the lid 4 is hinged. The lid 4 is discussed in more detail below. As can be seen in FIGS. 1a and 1b in particular, on the back of the housing 2 are wall fixings 21 and 22, with which the housing 2 can be mounted on a wall or other suitable surface.

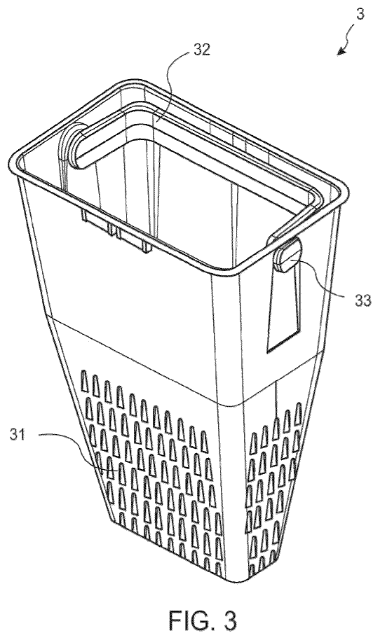

Positioned inside the housing 2 is a basket 3. The basket 3 is shown in more detail in FIG. 3. Similarly to the housing 2, the basket 3 is rectangular in cross section, tapering from an open top to a closed bottom. As can be seen in FIG. 1b in particular, the basket 3 is sized so that it is contained fully within the housing 2, with there being a space between the top of the basket 3 and the top of the housing 3, and also between the bottom of the basket 3 and the bottom of the housing 2.

Roughly the upper half of the basket 3 is sized and in particular tapered so that its exterior surface touches the interior surface of the housing 2. In other words, the upper half of the basket 3 tapers at the same rate as the corresponding part of the housing 2. In this way, when the housing 2 is placed within the basket 3, it is kept in position by the upper part of the basket 3 pushing against the corresponding part of the housing 3. Roughly the lower half of the basket 3 then tapers more quickly than the corresponding part of the housing 2, so that there is a gap between the exterior surface of the lower half of the basket 3 and the corresponding interior surface of housing 2, as well as between the bottom of the basket 3 and the bottom of the housing 2.

The lower half of the basket 3 comprises on each side six rows of holes 31. The holes are 3-4 mm in diameter. The holes 31 provide an opening between the interior of the basket 3 and the gap between the exterior of the lower half of the basket 3 and the housing 2.

Within the top end of the basket 3 is a handle 32, which has at each end a post 33 that extends through a hole on either side of the basket 3. This allows the handle 32 to be rotated between a horizontal storage position in which it is entirely within and below the top of the basket 3, and a vertical usage position in which it extends above the top of the basket 3 and can be used to remove the basket 3 from the housing 2.

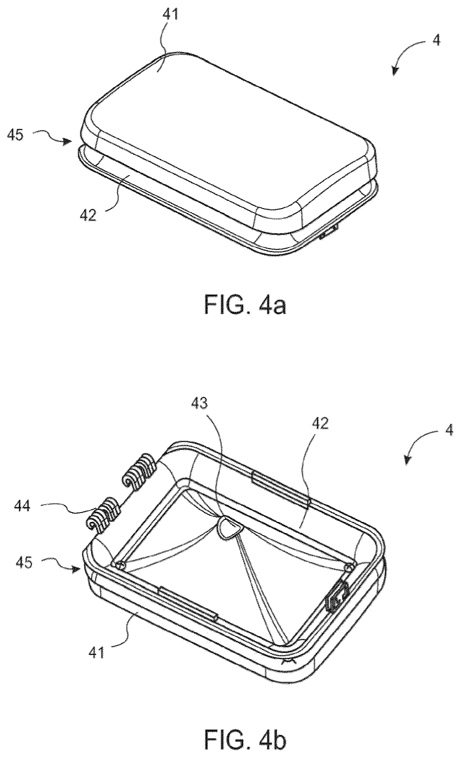

As mentioned above, the flying insect trap 1 also comprises a lid 4. The lid 4 is attached to the housing 2 by means of hinges 44 that engage with the hinge fittings 24 of the housing 2, so that the lid 4 can rotate between the closed position shown in FIG. 1a and the open position shown in FIG. 1b. The lid 4 is shown in more detail in FIGS. 4a to 6b.

The lid 4 comprises a cover 41 and a funnel 42. The funnel 42 extends from a flared top downwards to a hole 43 at its centre, so that when the lid 4 is in closed position on the housing 2, the funnel 42 extends downwards into the interior of the housing 2. The funnel 42 has at each corner a post 48, into which corresponding posts 49 on the cover 41 extend, to fix the cover 41 over the top of the funnel 42. The posts 48 and 49 space apart the cover 41 and the top of the funnel 42, so providing a gap 45 around each side of the lid 4. Thus, when the lid 4 is closed on the housing 2, this a route for insects from outside the lid 4, through the gap 45, the hole 43 and into the interior of the housing 2.

In use, the housing 2 of the trap 1 is partially filled with a volume of an insect-killing liquid, for example 1.5 litres of the insect-killing liquid so that the top of the insect-killing liquid is at the 1.5 L marking 27. As the housing 2 is transparent the level of liquid can be seen from the exterior of the housing 2, and so it can be seen when the amount of insect-killing liquid has reduced and requires replenishment, for example due to evaporation of the insect-killing liquid and/or small amounts being lost when the trap 1 is emptied of corpses of flying insects, as discussed in more detail below. 0.5 L and 1L markings on the exterior of the housing 2 may be used for this purpose, for example the insect-killing liquid could be replenished when the level of the insect-killing liquid has fallen to the 1 L marking.

The housing 2 may be filled with insect-killing liquid with the basket 3 either removed from the housing 2, or with it in position within the housing 2. In either case, because of the holes 31 in the basket 3, when the basket 3 is present within the housing 2, the insect-killing liquid can freely flow between the interior and exterior of the basket 3. Whether the basket 3 is within the housing 2 when it is being filled with insect-killing liquid, or is put there only subsequently, this will result in there being a volume of insect-killing liquid within the basket 3 and the remainder being between the exterior of the basket 3 and the housing 2, with the top of the insect-killing liquid both inside and outside the basket 3 being at the same level, i.e. at around the level of the 1.5L marking 27.

In order to use to catch flying insects, the trap 1 is fixed to a wall or other suitable surface by means of the wall fixings 21 and 22. The lid 4 is closed, so that the trap 1 is in the closed configuration shown in FIG. 1a, in which the only route from the exterior of the trap 1 to the interior is via the gap 45 in the lid 4.

Over time the insect-killing liquid will begin to evaporate, with this being exacerbated when it is hot and/or the trap 1 is in direct sunlight. The evaporating insect-killing liquid will escape from the trap 1 via the gap 45 in the lid 4. Flying insects will be attracted by the evaporating insect-killing liquid and will enter the gap 45, and travel down the funnel 42 through the hole 43 into the interior of the housing 2, and particularly into the interior of the basket 3. The flying insects will not easily be able to escape back through the small hole 43 of the funnel 42, and will instead in due course come into contact with the insect-killing liquid in the basket 3, in which they will die.

In this way, the trap 1 will attract and kill flying insects. All of the flying insects will die in the insect-killing liquid inside the basket 3, and so their corpses will not be visible from outside the trap 1, even though the housing 2 of the trap 1 is transparent and allows the level of insect-killing liquid inside the housing 2 to be seen from outside the trap 1.

When it is desired to empty the trap 1 of corpses of flying insects, the lid 4 is opened and the basket 3 is removed from the housing 2 using the handle 32. As the basket 3 is lifted away from the housing 2, the insect-killing liquid in the basket 3 will flow through the holes 31, so that it (or at least the vast majority of it) stays within the housing 2 and is not removed along with the basket 3. However, due to the size of the holes 31, the corpses of the flying insects that have been killed by the insect-killing liquid will be retained within the basket 3. In this way, the corpses of the flying insects can be easily disposed of, and the insect-killing liquid can continue to be used and does not need to be disposed of along with the corpses of the flying insects.

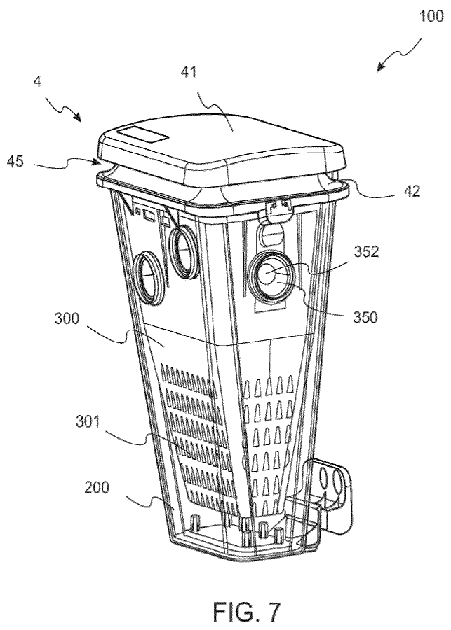

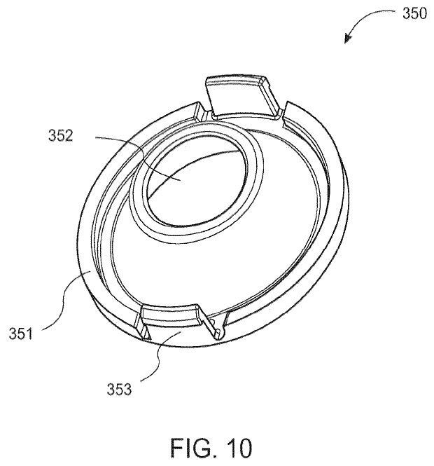

A flying insect trap in accordance with a second embodiment of the invention is now described with reference to FIGS. 7 to 10. As can be seen from FIG. 7, the flying insect trap 100 is similar to the flying insect trap 1 of the first embodiment, and in particular shares parts such as the lid 4. However, the flying insect trap 100 has a different housing 200 and basket 300, which provide additional holes through which flying insects can enter the housing 200, and which are designed to be particularly attractive to wasps.

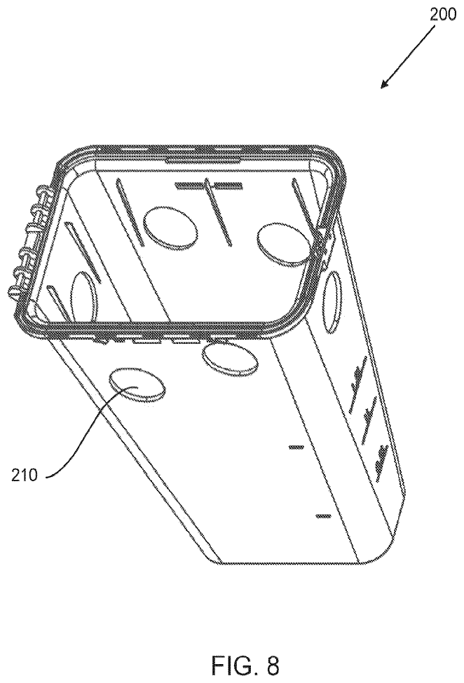

As shown in FIG. 8, the housing 200 is identical to the housing 2 of the first embodiment, except that it has on its top part, which corresponds to the top part of the basket 300, six holes 210, each roughly 5 cm in diameter. The two long sides of the housing 200 each comprise two holes 210, which the two short sides of the housing 200 each comprise one hole 210.

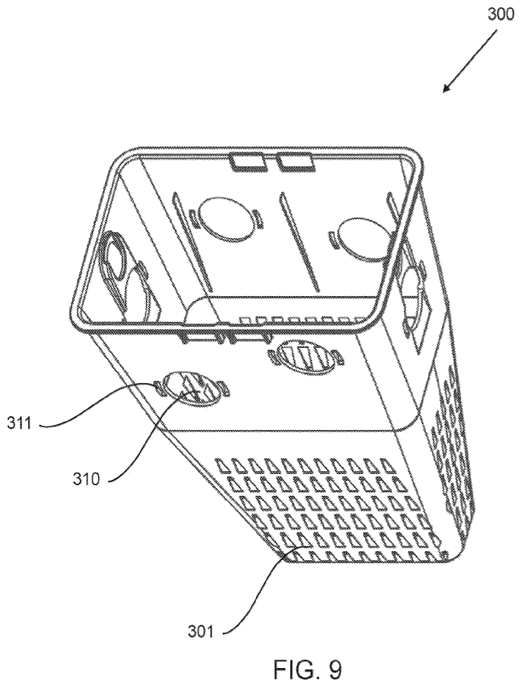

As shown in FIG. 9, the basket 300 is similarly identical to the basket 3 of the first embodiment, except that it has on its top part six holes 310, again each roughly 5 cm in diameter, which correspond to the six holes 210 of the housing 200. Each of the six holes has on the left and right sides a slot 311. When the flying insect trap is assembled as shown in FIG. 7, in each of the six holes 310 of the basket 300 there is positioned a funnel 350, one of which is shown in FIG. 9. Each funnel 350 has on opposite sides clips 353, which slip into the slots 311 of a hole 310 to hold the funnel in place over the hole 310. The funnel 350 tapers from a rim 351 to a hole 352 of roughly 2 cm in diameter. When a funnel 350 is in position in a hole 310 it extends from the outside of the basket 300 to the interior of the basket 300.

When the basket 300 is positioned within the housing 200, the holes 310 of the basket 300 are aligned with the holes 210 of the housing 200, with the rim 351 of each funnel 350 providing a seal between the exterior surface of the basket 300 and the interior surface of the housing 200. In this way, each funnel 350 allows a flying insect to pass from the exterior of the housing 200 into the interior of the basket 300 (and prevents the flying insect being easily able to escape again), without it being possible for the flying insect to access the space between the basket 300 and the housing 200. In use, this provides another route for flying insects to enter the trap 1 and be killed by the insect-killing liquid.

In embodiments the basket 300 is pink in colour, as this colour has been found to be particularly attractive to wasps.

While the present invention has been described and illustrated with reference to particular embodiments, it will be appreciated by those of ordinary skill in the art that the invention lends itself to many different variations not specifically illustrated herein. By way of example only, certain possible variations will now be described.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A flying insect trap, comprising:
a housing for holding insect-killing liquid;
a basket removably mounted within the housing, wherein the basket comprises a plurality of holes, and wherein the housing and basket are arranged so that a portion of the insect-killing liquid within the housing can pass through the holes into the interior of the basket;
wherein each of the housing and the basket comprises at least one opening, such that a flying insect can travel from outside the housing through the at least one openings of the housing and the basket to the interior of the basket;
and wherein the basket is arranged so that when the housing is holding insect-killing liquid and there are one or more insect corpses in the insect-killing liquid within the basket, when the basket is removed from the housing, the one or more insect corpses remain within the basket and are removed from the housing.

2. A flying insect trap as claimed in claim 1, wherein the housing is formed of transparent material.

3. A flying insect trap as claimed in claim 1, wherein the basket is formed of opaque material.

4. A flying insect trap as claimed in claim 1, wherein any opening in the housing allows an insect to travel only from the outside of the housing to the interior of the basket.

5. A flying insect trap as claimed in claim 1, wherein the at least one openings of the housing and the basket are at least partially aligned.

6. A flying insect trap as claimed in claim 1, wherein one or more of the at least one openings of the housing and the basket comprises a funnel, with the smaller end of the funnel being towards the interior of the basket.

7. A flying insect trap as claimed in claim 1, wherein the basket is removable from the housing through an opening in the housing, and wherein the flying insect trap further comprises a lid that covers the opening.

8. A flying insect trap as claimed in claim 7, wherein the lid comprises at least one opening, such that a flying insect can travel from outside the housing through the at least one openings of the lid, the housing and the basket to the interior of the basket.

9. A flying insect trap as claimed in claim 8, wherein the at least one opening of the lid comprises a funnel, with the smaller end of the funnel being towards the interior of the basket.

10. A flying insect trap as claimed in claim 1, wherein the housing comprises at least one further opening on a side of the housing, such that a flying insect can travel from outside the housing through the at least one further opening to the interior of the basket.

11. A flying insect trap as claimed in claim 1, wherein the basket is pink in colour.

12. A flying insect trap as claimed in claim 1, comprising insect-killing liquid within the housing.

13. A flying insect trap as claimed in claim 10, wherein the insect-killing liquid is an insect attractant.

14. A kit of parts for a flying insect trap as claimed in claim 1, comprising:
a housing for holding insect-killing liquid;
a basket arranged to be removably mounted within the housing, the basket comprising a plurality of holes.

15. A kit of parts as claimed in claim 14, further comprising a lid for covering an opening in the housing.

16. A flying insect trap as claimed in claim 2, wherein the basket is formed of opaque material.
